(19) United States
(12) Patent Application Publication
(10) Pub. No.: US 2013/0162971 A1
(43) Pub. Date: Jun. 27, 2013

(54) OPTICAL SYSTEM

(71) Applicant: Hilti Aktiengesellschaft, Schaan (LI)

(72) Inventors: Andreas Winter, Feldkirch (AT); Helmut Seifert, Serba (DE); Christoph Wuersch, Werdenberg (CH); Torsten Gogolla, Schaan (LI)

(21) Appl. No.: 13/724,176

(22) Filed: Dec. 21, 2012

(30) Foreign Application Priority Data
Dec. 23, 2011 (DE) 10 2011 089 837.9

(51) Int. Cl. G01C 3/08

(52) U.S. Cl. CPC G01C 3/08
USPC 356/4.01

(57) ABSTRACT

An optical system is disclosed. The optical system includes a radiation device having a rotational pointer, in particular a rotary laser, for the contactless display of an azimuth plane on a circumferentially disposed target object, which is configured to generate a light signal rotating or turning in the azimuth plane when emitting optical pointer radiation. A control and computing unit, which is configured to put the rotational pointer into a first operating mode or a second operating mode, where a light signal rotating continuously over a round angle by the rotational pointer can be generated in the first operating mode and a light signal that is rotatable in a limited angular sector of a round angle can be generated in the second operating mode. A radiation receiver is configured to receive and/or reflect optical radiation.

This application claims the priority of German Patent Document No. DE 10 2011 089 837.9, filed Dec. 23, 2011, the disclosure of which is expressly incorporated by reference herein.

### BACKGROUND AND SUMMARY OF THE INVENTION

The invention relates to an optical system.

Optical radiation devices are available in the meantime in a wide variety of forms as a resource for carrying out display and measuring tasks in the environment of a target object. In addition, an optical radiation device may be manually operated and/or be attached to a tripod as needed.

In the meantime hand-held, comparatively simple manual laser measuring instruments for distance measuring tasks are known, for example, from German Patent Document No. DE 198 36 812 A1. So-called total stations are also known, which, in addition to distance measuring, also allow information about a rotational angle relative to a predetermined coordinate system or the like. A total station may include an optical radiation device in the form of a scanner, such as in German Patent Document No. DE 697 33 014 T2, in order to scan the position of selected points on the surface of an object in a three-dimensional space comparatively quickly and precisely. A cluster of points is generated which represents the scanned positions of the selected points with an indication of distance and angle. This type of device is also designated as a field digital vision (FDV) module and allows scan guidance for scanning only a partial surface of a target object in a three-dimensional space. The scan system contains dual orthogonal scan mirrors, galvo motors as well as coders to guide the laser beam and determine the azimuth and vertical angles of the laser beam from the mirror positions. The laser is pulsed and the distance to the object is measured via the run time of the transmitter-receiver to the object and back. The module is supported in a forked mount in order to make it possible to aim at a very limited field of vision on a target object. As a rule, these types of total stations are based on the limited concept of laser distance measuring with an expanded field of vision.

An optical distance measuring device that is likewise expanded with respect to the field of vision for geodesic and industrial surveying of both cooperative and non-cooperative target objects is known from German Patent Document No. DE 198 40 049 C5 in which separable bundles of radiation having differing divergences on a single optical axis are able to be guided to a target object for distance measurement.

A distance measuring instrument is designed as a surface coordinate measuring instrument in German Patent Document No. DE 10 2005 000 060 A1 and for this purpose has an optical distance measuring system, which is suitable for simultaneously determining a transverse distance and a longitudinal distance starting from a positioning means. Attached to a controlled swiveling means, the instrument is suitable with the detection of an angle for measuring a longitudinal and transverse distance to determine the surface coordinates of the positioning means by using trigonometric functions. This measuring instrument is also essentially based on the concept of distance measuring in a very limited angular range.

In contrast, European Patent Document No. EP 2 063 222 A2 discloses an optical display system of the type cited at the outset, specifically having a radiation device, which has a rotary laser for the contactless display of an azimuth plane on a circumferential target object, as well as a radiation receiver which is configured to receive and/or reflect optical radiation for the radiation device. The rotary laser is used exclusively as a pointer device, which is configured to emit optical pointer radiation. By using a control and computing unit, it can be operated in a circumferentially rotating operating mode, on the one hand, as well as in an operating mode that scans in the azimuth plane within an angular sector. The radiation receiver is used in this case as a remote control by means of which a switch from the rotating operating mode into the scanning operating mode may be brought about such that the pointer device is swiveled back and forth on the beam plane within an angular sector by the projection of the remote control. Even if the light conditions are poor, the laser beam of the pointer device is thus able to be detected precisely. This type of optical system that is designed as a display system can still be improved.

In particular, it is desirable to develop an optical display system for use with measurements for applications in the construction industry.

At this point, the present invention comes into play, the object of which is disclosing an improved optical system which includes an optical display system that can be operated in two operating modes. In particular, a display system of the type cited at the outset should be able to detect and display, in particular also to measure, distances and/or angles in both operating modes in an improved manner.

The invention starts from the consideration that particularly for applications in the construction industry, an optical system should have a rotational pointer, which can be operated in a rotating and a scanning operating mode. This prerequisite makes possible, among other things, the leveling or display of inclined surfaces on a circumferentially disposed target object. The invention also starts from the consideration that to avoid additional separate measuring means and measuring measures, such as, for example, separate distance measuring instruments or angle measuring devices or the like, it must be advantageously possible to further develop the radiation device to also fulfill measuring tasks. The invention has recognized that to fulfill this task, it is advantageous to continuously detect the current azimuth angle of the light signal of the rotational pointer as well as the distance of a measuring point of the distance measuring device for further processing in the first and second operating modes. In accordance with the invention, the radiation device is provided with an angle detection element and a distance measuring device in addition to the rotational pointer. In order to realize the concept of the invention, radiation guidance of the measuring radiation and the pointer radiation runs such that the distance measuring point can be placed on or in the direct vicinity of the light signal. Distance measuring can thus be carried out at the same location of the light signal or at least in its direct vicinity. In this way, because of the concept of the invention, an operator obtains, at the location of the light signal, measured value information about the angle of the light signal in the azimuth plane as well as about the distance of the measuring point, i.e., virtually of the light signal, to the radiation device or a reference point in the radiation device. The invention has recognized that this measure is able to be used in both operating modes for especially preferred further processing of the azimuth angle and the distance.

In the course of a preferred structural implementation, the rotational pointer has a rotatable pointer device, a radiation unit and rotation optics. The radiation unit is preferably designed in the form a laser unit. The distance measuring device preferably has a radiation unit, in particular a laser unit, and an optics unit with optical elements. In particular, the distance measuring device has transmitting and receiving optics, as well as a rotatable optical transmit path having an optical axis for emitting measuring radiation onto the target object and a rotatable receive path having an optical axis for receiving measuring radiation reflected and/or scattered back from the target object. Such a coaxially or biaxially structured transmit and receive path of transmitting and receiving optics of a distance measuring device allows contactless measurement of a distance from a measuring point on a target object to be realized. In particular, it is possible to realize different methods for distance measuring basically independent of the measuring radiation used. With these methods, for example, the distance from a target object is able to be determined in a contactless manner by using a run-time measurement, a phase measurement or a laser triangulation.

The radiation unit of the rotational pointer and the radiation unit of the distance measuring device may be identical, but do not have to be. As part of a comparatively compact and simply designed further development, it is possible to realize essentially identical pointer radiation and measuring radiation with an identical radiation unit for the rotational pointer and distance measuring device. In other words, the light signal and the measuring point are realized advantageously by a single radiation, which at the same time serves as the pointer radiation and measuring radiation.

For the possibly advantageous case of different radiation units for the rotational pointer and the distance measuring device, it is possible for the pointer radiation and the measuring radiation to preferably be realized with different radiation. The radiation may be different in particular in terms of wavelength and/or color. In this way, it is possible to make, for example, a light signal and a measuring point apparent to the operator with different colors one above the other or in the direct vicinity next to each other on a circumferential target object. If necessary, an optical axis for the radiation guidance of the pointer radiation of the rotational pointer and an optical axis for the radiation guidance of the measuring radiation of the distance measuring device in the radiation device may be disposed at least partially one above the other or at least para-axially to each other, in particular in the range of outcoupling optics of the radiation device.

In a preferred structural realization of the angle detection element, the angle detection element may be realized by a series of sensors disposed along an angle periphery of a pointer device of the rotational pointer. The sensors are advantageously used to detect radiation reflected by the light signal and are thereby able to detect a current azimuth angle of the light signal. Further developments of the angle detection element other than the one cited here can be realized depending upon needs and precision requirements for the angle detection element. In particular, an angle detection element may be realized as described in EP 2 063 222 A2, for example, the disclosure of which is hereby expressly incorporated by reference herein into the present application.

The radiation device and the control and computing unit are preferably arranged in a housing and compact manner.

As a part of an especially preferred further development in accordance with the concept of the invention, further processing of the azimuth angle and distance in particular in the first operating mode is configured especially preferably for applications in the construction industry and ancillary industries.

At least in the first operating mode, the angular velocity of the rotating light signal is preferably adaptively adjustable, wherein, in the first operating mode, the azimuth angle can be detected as a rotational angle of the continuously rotating light signal. With adaptation of the angular velocity, it is also possible even with comparatively limited arithmetic electronics to detect even complex geometry continuously with values for an azimuth angle and a distance. Alternatively, the rotation of the light signal and the detection of measured data may also be carried out incrementally. It has proven to be advantageous in particular that, at least in the first operating mode, a further processing module for the control and computing unit is configured to detect a spatial coordinate system of the target object by means of the values for an azimuth angle and a distance. The determination may be carried out especially advantageously with the determination of extremal points in a value list of the azimuth angle and the associated distance, e.g., it is possible to regularly determine a corner of a space based on an extreme point. Other imaging means and/or signaling means may be used advantageously to determine the spatial coordinate system of the target object. Plan information about the target object can be conveyed especially advantageously via an interface of the radiation device to the control and computing unit, for example.

The optical measuring system may be expanded advantageously by photoelectric image detection with viewfinder and camera optics disposed in the housing of the same. Viewfinder and camera optics preferably have an image path connecting these for detecting target points of the target object, in particular of the light signal and of the measuring point, as well as an image processing unit for creating a photoelectric image of the target object. Detection of the spatial coordinate system of the target object is also able to be supported thereby in an advantageous manner. The spatial coordinates of the target object are also able to be checked for consistency via the values of the azimuth angle and distances. In addition, photoelectric image detection also allows the system to approach and measure dedicated features in a targeted manner, such as, for example, corner points or edges of a space.

In addition, the radiation device advantageously has a tilt sensor, by means of which an inclination value can be conveyed to the control and computing unit. Thus, any correction or coordinate transformation may be carried out with respect to an inclination of the radiation device.

The aforementioned, preferred further developments may be used in an especially advantageous manner in the first operating mode for an independent leveling of the optical measuring system. The first operating mode especially preferably has a self-aligning mode that can be activated automatically via the control and computing unit. In the self-aligning mode it is preferably provided that the coordinate system of the radiation device can be automatically aligned and/or brought into conformity, in particular without operator interaction, with the coordinate system of a space of the target object. In particular, in addition or as an alternative, the coordinate system of the radiation device can be aligned and/or brought into conformity with the coordinate system of the plan information. In particular, it has proven to be advantageous to design the first operating mode to be invokable or be preset as the primary mode within the framework of a self-start mode of the control and computing unit. It is advantageous for an operator to be able to use an optical measuring system especially effectively, for example, in construction within the course of one of the aforementioned further developments, because, when it is turned on, it automatically goes into a self-adjusting mode of the first operating mode. Upon conclusion thereof, the coordinate system of the radiation device is advantageously aligned with the coordinate system of a space of the target object and/or a coordinate system of plan information; directly afterwards, an operator is thus able to use the optical measuring system for dimensioning in the coordinates of the space of the target object or in the coordinates of plan information. It has proven to be advantageous in particular in a further development to use point and/or line pointers and/or a pilot beam pointer of the radiation device to display the coordinate system of the rotational pointer, in particular in an aforementioned aligned state.

A point and/or line pointer preferably indicates an X-axis or Y-axis of the spatial coordinate system that lies in the azimuth plane, which can be displayed, for example, as a parallel line to a room wall or the like. A pilot beam pointer of the radiation device preferably indicates a polar axis, e.g., a Z-axis or the like, as a perpendicular line to an azimuth plane. A pilot beam pointer is able to display the polar axis downwardly and/or upwardly. A point or line indicator may be realized in particular in the form of an axicon or like optics with a separate radiation device. In addition or as an alternative, radiation of the radiation unit of the rotational pointer and/or of the distance measuring device may be used.

In accordance with the concept of the invention, the optical measuring system has to support the second operating mode, in addition to the radiation device, and a radiation receiver that can be connected in a communicable manner with the radiation device, which is configured to receive and/or reflect optical radiation from the radiation device. The radiation receiver preferably also has transmitting and receiving means for communication with the radiation device. In particular, this makes it possible to establish a data connection based on the control radiation between the rotational pointer and the radiation receiver. A transmitting and receiving device for the control radiation may be designed, for example, for the use of infrared radiation or radio waves as control radiation. In general, a further development provides for sensor means on the radiation receiver which are configured to place and hold the light signal and/or the measuring point at the radiation receiver by means of the rotational unit and feedback of the same, this also with movement of the radiation receiver. Sensor technology of the radiation receiver that is designed to receive and/or reflect optical radiation—in particular of the pointer radiation and/or measuring radiation—may be configured, for example, as an optical sensor, in particular advantageously as a multi-quadrant optical sensor. The advantage of a multi-quadrant optical sensor is that a capture cross-section of the radiation receiver is enlarged and suitable for placing the light signal more easily on the radiation receiver for the operator. In particular, this property is advantageous in combination with a scan mode of the rotational pointer provided in the second operating mode in a limited angular range of the azimuth angle. Particularly in the second operating mode, the azimuth angle or the rotational angle of the light signal that is rotated in a predefinable manner may be continuously detected in an advantageous manner as well as the distance from a reference point of the radiation device to the radiation receiver. In a second operating mode that is advantageously configured in this manner, it is possible for the operator to move the radiation receiver with the light signal and the distance measuring point so long until the location thereof coincides with a coordinate in a coordinate system of the space of the target object, which coordinate is predetermined by the placement of the light signal and/or measuring point, and/or with plan information. The movement of the radiation receiver may be carried out in a targeted manner, wherein the user is guided by the system by means of suitable display means (e.g., arrows or the like). In addition, the light signal may be fixed on an azimuth angle matching a predefinable coordinate, and, with continuous distance measurement, the user can move the radiation receiver along the light signal until the distance to the radiation receiver that matches the predefinable coordinate is displayed on the same. In this way, determining a coordinate is advantageously reduced to a one-dimensional search. In a second operating mode configured as a tracking mode, it is possible by means of the radiation receiver to determine, for example, a position of a construction object such as a column, wall, window, or the like in a circumferentially disposed target object. Until now, these types of determination measures had to be carried out with the aid of several optical systems, i.e., separate display and measuring systems.

The optical system preferably has a suitable display interface for the operator in order to, for example, provide the operator with current coordinate values when he/she moves the radiation receiver in the second operating mode. For example, this may be a display on the radiation receiver itself. This may preferably be a projection means, by means of which the position and/or coordinate data of the light signal and/or measuring point, i.e., of the radiation receiver, can be displayed and/or can be projected onto a target object. In particular, it has proven to be advantageous to design an azimuth angle of the light signal and a distance of the measuring point to be displayable, in particular on request, or depending upon need, even continuously displayable.

As a whole, the concept of the invention in the further development of the second operating mode offers the possibility of displaying a selected coordinate point in the coordinate system of the rotational pointer in an aligned state. A coordinate display mode is preferably definable for this in the second operating mode via the control and computing unit. Displaying a position of the radiation receiver may preferably be further developed with point and/or line pointers as well as a pilot beam pointer.

Exemplary embodiments of the invention are described in the following on the basis of the drawings. These drawings are not necessarily supposed to represent the exemplary embodiments to scale; rather the drawings are executed in a schematic and/or slightly distorted form when this is useful for explanatory purposes. Reference is made to the pertinent prior art with respect to additions to the teachings directly identifiable from the drawings. It must be taken into consideration in this case that a wide range of modifications and changes related to the form and detail of an embodiment may be undertaken without deviating from the general idea of the invention. The features of the invention disclosed in the description, the drawings as well as in the claims may be essential for the further development of the invention both separately as well as in any combination. Moreover, all combinations of at least two features disclosed in the description, the drawings and/or the claims fall within the scope of the invention. The general idea of the invention is not restricted to the exact form or detail of the preferred embodiment described and depicted in the following or restricted to a subject matter which would be limited as compared to the subject matter claimed in the claims. In the case of any dimensioning ranges given, values within the stated limits are also meant to be disclosed as limit values, and be applicable at will and claimable. For the sake of simplicity, the same reference numbers are used in the following for identical or similar parts or parts having an identical or similar function.

Additional advantages, features and details of the invention are disclosed in the following description of the preferred exemplary embodiment as well as on the basis of the drawings.

### BRIEF DESCRIPTION OF THE DRAWINGS

FIG. 1 illustrates a first preferred embodiment of an optical system having a radiation device and a radiation receiver to realize a compact measuring system, which is suitable for construction design in an azimuth plane; the optical system is shown in a first operating mode, wherein a light signal rotating continuously about a round angle of 360° is generated;

FIG. 2 illustrates another preferred embodiment of an optical system similar to FIG. 1, in which, as a variation, the radiation receiver is provided with a quadrant sensor to receive and reflect optical pointer and/or measuring radiation; the optical system is depicted in a second operating mode, wherein a light signal that is rotatable in a limited angular range of the round angle is generated; and

FIG. 3 provides a flow chart of process steps for operating the optical system of FIG. 1 and FIG. 2 in the first and second operating mode.

### DETAILED DESCRIPTION OF THE DRAWINGS

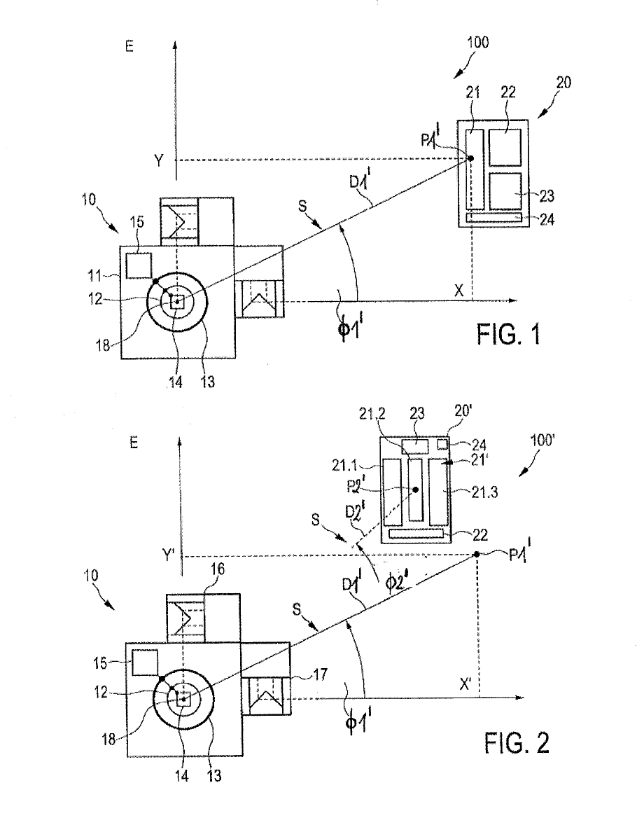

FIG. 1 depicts an optical system 100 designed for display and measurement in an azimuth plane on a circumferentially disposed target object, the optical system having a radiation device 10 and a radiation receiver 20 allocated to the radiation device 10. In this case, the radiation device 10 has, in a housing 11, a rotational pointer 12 configured as a rotary laser, an angle detection element 13 allocated thereto and configured here as an absolute encoder 13, a distance measuring device 14 and a control and computing unit 15 connected thereto to transmit data and adjustment values. Two axicons 16, 17 are also attached laterally on the housing 11 of the radiation device 10, which are used to display an X-axis and Y-axis (designated as X and Y) of the coordinate system of the radiation device 10. In the present case, the rotational pointer 12, the distance measuring device 14 and the axicons 16, 17 guide radiation of a single radiation unit 18 configured here as a laser unit for generating optical radiation S. The optical radiation S is constituted here in the form of bundled and pulsed radiation; it also serves as measuring radiation for the distance measuring device 14 as well as pointer radiation for the rotational pointer 12. Optics (not shown) of the radiation device 10 are configured with optical elements that are known per se such as mirrors, lenses, beam splitters and the like. Radiation guidance of optical radiation S is designed by means of the optical elements in such a way that at a point P disposed on a surface of the circumferentially disposed target object, both a light signal for displaying an azimuth angle φ in an azimuth plane E on the circumferentially disposed target object, as well as a measuring point for determining a distance D of the point P from the location of the radiation unit 18, are formed as a reference point. In the present case, the distance measuring device 14 is configured for contactless continuous measurement of the distance D between the radiation unit 18 and point P serving as the measuring point on the target object by means of optical radiation S. The distance measuring device is able to transfer a measured value for the distance D to the control and computing unit 15. The angle detection element 13 is configured here to continuously detect a current azimuth angle φ of the light signal formed on point P and transfer a suitable measured value for the azimuth angle φ to the control and computing unit 15. The control and computing unit features suitable processor and storage means to allocate the current azimuth angle φ of the light signal at point P to the distance D of the measuring point at point P and to detect continuously for further processing. In the present case, the further processing provides above all for a transformation of the polar coordinates D, φ into Cartesian coordinates X, Y. The further processing also provides for making available the coordinates that are thusly determined, be it in the form of polar coordinates or in the form of a Cartesian coordinate, for a first operating mode I and a second operating mode II of the optical system 100.

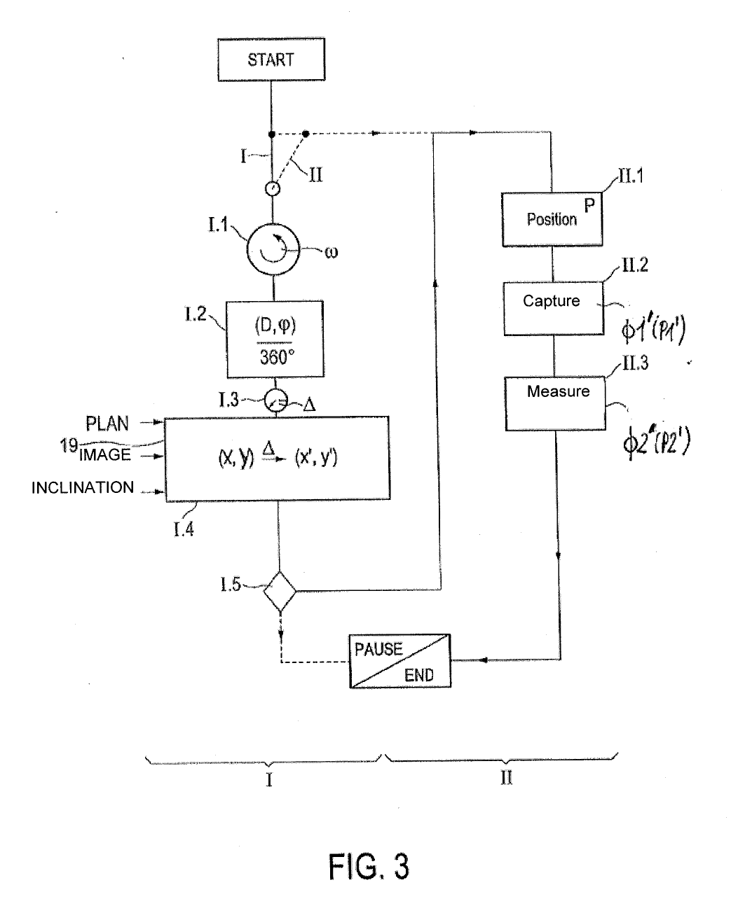

In a first operating mode I explained in reference to FIG. 1 and FIG. 3 and which is symbolized in FIG. 3 by a first switch setting, after the START step of the optical measuring system 100 in a Step I.2, a light signal with changeable values for D and φ and rotating continuously around a round angle of 360° is able to be realized in the azimuth plane E with the emitting of the optical radiation S as pointer radiation by means of the rotational pointer 12. To this end, the continuously changing distances D and azimuth angle φ of the point P are continuously detected on a circumferential surface of the target object of plane E by the control and computing unit 15. In order to be able to adjust the measurement and detection time, particularly for the distance D, in a modified time interval for the distance D and the angle φ, the angular velocity co of the rotating light signal, i.e., of the rotating point P, is set adaptively to begin with in a Step I.1. This is not necessarily constant in the present case, but may be variably adjusted adaptively in a step-measure mode or a continuously measuring mode, depending upon expediency. In particular, a Step I.2 may run through a round angle 360° multiple times so that a measured value recording may be distributed over several passes of the round angle 360°. Upon conclusion of Step I.2, it is possible for the control and computing unit 15 to suggest from the list of measured values for D, φ in a round angle range of 360° the spatial coordinate system of a rectangular space serving as the target object in the present case. The coordinate origin and the direction of the coordinate axes may be taken automatically from a plan or be determined through user interaction. After START, the optical system is initially in the first operating mode I depicted in FIG. 1. The spatial coordinate system is rotated and/or displaced by a transformation angle Δ vis-à-vis the coordinate system of the radiation device 10. The control and computing unit 15 is configured here to determine a subsequent coordinate transformation from the spatial coordinate system (X, Y) as a rotation around the transformation angle Δ in the spatial coordinate system (X′, Y′). To do so, in a further process step I.3, the transformation angle Δ is determined and then in a process step I.4, the rotation of the radiation device 10 around a transformation angle Δ is undertaken such that the axicons 16, 17 of the radiation device 100 display the spatial coordinate system (X′, Y′) of the space of the target object in the azimuth plane E, wherein in the case of an additional displacement, a parallel offset must still be taken into account.

As the case may be, additional information from a PLAN, an IMAGE or an INCLINATION may be made available in a suitable arithmetic module for Step I.4 in order to be able to make execution of process step I.4 more precise. In the present case, the control and computing unit 15 has a symbolically represented interface 19 for transmitting information from a plan PLAN, a photoelectric image IMAGE and/or an inclination angle INCLINATION, which may be relevant for the radiation device 10.

After interacting with the operator in a process step I.5, the radiation device 10 may remain initially in a state rotated around the transformation angle Δ and depicted in FIG. 2 or until a measuring process is ended or paused. The spatial coordinate system (X′, Y′) is displayed in this state. In a modified embodiment not shown here, the axes as displayed by the axicons 16, 17 may be displayed in a different choice of color, for example the X-axis X, X′ in red and the Y-axis Y, Y′ in green.

Overall, after the optical system 100 is set up and turned on, the first operating mode I depicted in FIG. 1 and FIG. 3 facilitates an automatic independent adjusting of the radiation device 10 in a coordinate system (X′, Y′) of the space in the azimuth plane E. To this end, based on the measured values for D, φ detected in a round angle 360°, lines or edges of the space are recognized and thus the relative alignment of the radiation device 10 relative to the space is determined via the transformation angle Δ. Then the radiation device 10 is adjusted in the coordinate system of the space by rotating around the transformation angle Δ. For this purpose, the radiation device 10 may be attached to a suitable bracket device or adjustment platform, which reacts to input from the control and computing unit 15 via suitable stepper or continuously adjustable motors.

In an altered embodiment (not shown here) it is possible to provide the axicons 16, 17 with suitable motors such as a stepper motor or the like in order to align the axicons independent of the housing 11 of the radiation device 10 in such a way that they rotate a point and/or line display of one axis X, Y to an axis X′, Y′ around the transformation angle Δ.

In the present embodiment, it is provided in particular that the coordinate system (X′, Y′) of the space can be identified with a coordinate system of the outline made available by a plan. In other words, in the present embodiment, based on the list of measured values for D, φ, the control and computing unit 15 in a manner of speaking makes the outline of the space in the azimuth plane E of the target object available after appropriate conversion into Cartesian coordinates. An outline that is determined in such a way is able to be identified with an outline of a plan via plan information PLAN. This identification may also be checked, for example, by an image information IMAGE. In short, after the optical system 100 is set up and turned on, the first operating mode I advantageously serves the operator by automatically detecting the outline of a space in the target object and identifying it with a corresponding outline of a plan. If several outlines are available in the plan information PLAN, the optical system 100 is able to independently identify which of the plans from the plan information PLAN is correct. Interaction with the operator is dispensed with to the greatest possible extent, which considerably facilitates application. For example, identification may take place based on the greatest conformity, for instance by comparing coordinates according to the method of the least squares or as the case may be an optimization method. If there are uncertainties that are not negligible, the operator may be consulted however.

It is possible in particular for the operator, for example through interaction with a display or a projection surface generated by the radiation device 10, to identify a suitable plan/outline of the space of the target object. To generate a projection surface, the radiation device has a mini-projector (not shown), which generates the projection as an operator interface. For example, a projection could be made on a suitable wall or a floor of a room of the target object. In particular, a current position of a point P or P′ in particular an actual position of a point P and a target position of a point P′ is able to be displayed or projected for a second operating mode II described in the following.

In the second operating mode II represented by the second switch setting in dashes in FIG. 2 and FIG. 3, it is possible to automatically identify a defined stake-out point, shown as an example in FIG. 2, as a target position of a point P′ in the spatial coordinate system (X′, Y′). FIG. 2 essentially shows the optical system 100 from FIG. 1 in a slightly modified form of an optical system 100′. It differs from the optical system 100 in FIG. 1 in terms of the design of the radiation receiver 20′. In contrast to the radiation receiver 20, the radiation receiver 20′ with a quadrant detector 21′ is equipped with three detector fields 21.1, 21.2, 21.3, which in interaction with the radiation device 10 allow an adjustment of the optical radiation S in a center region 21.2 of the quadrant detector 21′.

The radiation receiver 20 of FIG. 1 has a simple detector 21 and a display device 22 for displaying a position of the radiation receiver 20. In addition, an input device 23 is provided, via which the radiation device 10 is able to be controlled by user inputs. For this purpose, the radiation receiver has a transmitting and receiving device 24, which is able to communicate wirelessly with the radiation device 10 via control radiation (not shown). Accordingly, the radiation device 10 has a transmitting and receiving device (not shown) for the control radiation in order to form the communication link to the radiation receiver 20.

In the present case depicted in FIG. 2, the same reference numbers as with of optical system 100 are used for identical or similar parts, or parts with an identical or similar function of the optical system 100′. FIG. 2 shows the optical system 100′ as compared to the optical system 100 of FIG. 1 in a state in which the radiation device 10 and/or the axicons 16, 17 are adjusted to the spatial coordinate system (X′, Y′) of the space of the target object in the azimuth plane E. The latter is rotated in the previously described manner around a transformation angle Δ to the original coordinate system (X, Y) of the radiation device 10.

In a second operating mode II, it is provided that to begin with the position P₁′ at a polar coordinate φ₁′, D₁′ be determined in a process step II.1. This state of the optical system 100 is depicted in FIG. 1. In this state, in a second process step II.2, a so-called capturing of the point P₁′ takes place, i.e., the optical radiation S as measuring and pointer radiation, at the radiation receiver 20 or 20′ in a process step II.2.

In a further Step II.3, a measurement of a measuring point P₂′ may take place, which is predefinable in a known manner, for example, at the coordinates φ₂′, D₂′. An operator may input corresponding coordinates—in either Cartesian form or polar form—via an input field 23 on the receiver 20. Normally, it will prove to be especially advantageous, however, that an operator simply moves the receiver 20′ until he/she gets a display 22 on the receiver 20 or a projection made by the radiation device 10, which displays the coordinates of the predetermined point P2′, i.e., the new rotational angle φ₂′ of P₂′ and the new distances D₂′ of P₂′. As an alternative, the coordinates may also be displayed or input as Cartesian coordinates. This step that is designated as measurement II.3 therefore includes a change in the position of the light signal and of the measuring point from point P₁′ to the point P₂′ with a change in the coordinates (D₁′, φ₁′) to (D₂′, φ₂′).

Basically, this may take place in a first variant in that the measuring station swivels the optical radiation S to the corresponding new angle φ₂′ and, as soon as the radiation receiver 20′ is located in angle φ₂′ at the correct distance D2′, the radiation receiver emits an optical or acoustic signal, for example. Alternatively, an operator may move the radiation receiver 20′ together with the radiation S, i.e., the distance measuring point and the light signal, in a captured state until the correct position is signaled. The movement of the radiation receiver can be guided by the system in a targeted manner in that a movement direction is suggested to the operator by a suitable display means on the radiation receiver (e.g., arrows or the like). Introducing a marking on the floor or on a wall or a like location of a target object is facilitated for the operator. The radiation receiver 20′ has an optical pointer device (not shown) such as an upward and downward pilot beam and also lateral pointer devices.

Overall, the optical system 100, 100′ makes it possible for an operator to automatically approach points P1′, P2′, P3′ . . . etc., sequentially, e.g., stake-out points defined in the plan, in that he/she moves the radiation receiver 20, 20′ respectively to a corresponding position. It may also display the measuring radiation S and a signal of the optical system 100, 100′ as the corresponding position. Thus, it is possible to simply stake out planned recorded surveying points in an azimuth plane E for columns, walls, doors, windows or the like.

The optical system 100, 100′ especially preferably has corresponding MMI functions on the receiver 20, 20′, which are not marked separately. It is also conceivable for the receiver 20, 20′ to graphically represent, for example, also via a photoelectric imaging camera or the like, at which location the radiation receiver 20, 20′ is situated in the spatial coordinate system (X′, Y′) of the space in the azimuth plane E.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An optical system, comprising:
a radiation receiver; and
a radiation device including:
a rotational pointer, wherein a contactless display of an azimuth plane on a circumferentially disposed target object is displayable by the rotational pointer and wherein the rotational pointer is configured to generate a light signal rotating in the azimuth plane when emitting optical pointer radiation;
a control and computing unit configured to put the rotational pointer into a first operating mode or a second operating mode, wherein a light signal rotating continuously or incrementally over a round angle by the rotational pointer is generateable in the first operating mode and wherein a light signal that is rotatable in a limited angular sector of a round angle is generateable in the second operating mode;
an angle detection element, wherein a current azimuth angle of the light signal is detectable and transferrable to the control and computing unit by the angle detection element; and
a distance measuring device configured for contactless measurement of a distance between a reference point and a distance measuring point on the target object or on the radiation receiver by optical measuring radiation and for transferring the distance to the control and computing unit;
wherein the control and computing unit is configured to detect the current azimuth angle and the distance for processing in the first and second operating modes.

2. The optical system according to claim 1, wherein an optical axis for radiation guidance of the optical pointer radiation and an optical axis for radiation guidance of the optical measuring radiation are disposed partially one above the other or at least para-axially to each other.

3. The optical system according to claim 1, wherein at least in the first operating mode, an angular velocity of the rotating light signal is adaptively adjustable, and wherein, in the first operating mode, the current azimuth angle is detectable as a rotational angle of the continuously rotating light signal.

4. The optical system according to claim 1, wherein at least in the first operating mode, the control and computing unit is configured to detect spatial coordinates of the target object by utilizing the current azimuth angle and the distance.

5. The optical system according to claim 1, wherein the radiation device further includes an interface via which plan information is conveyable to the control and computing unit.

6. The optical system according to claim 1, further comprising a photoelectric image detection element with viewfinder and camera optics disposed in a housing of the radiation device and an image processing unit for creating a photoelectric image of the target object.

7. The optical system according to claim 1, wherein the radiation device further includes a tilt sensor, wherein an inclination value is conveyable to the control and computing unit by the tilt sensor.

8. The optical system according to claim 1, wherein in the second operating mode, the current azimuth angle is continuously detectable by the radiation receiver by a rotational angle of the light signal that is rotated in a predefinable manner.

9. The optical system according to claim 1, wherein the current azimuth angle of the light signal and the distance are displayable on request.

10. The optical system according to claim 1, further comprising display means for displaying position data and/or projection means for projecting the position data onto a target object.

11. The optical system according to claim 1, wherein the radiation receiver is configured to emit a control radiation wherein a data connection based on the control radiation is establishable between the radiation device and the radiation receiver.

12. The optical system according to claim 1, wherein the optical pointer radiation and the optical measuring radiation are formed by a same optical radiation.

13. The optical system according to claim 1, wherein the optical pointer radiation and the optical measuring radiation are different in terms of wavelength and/or color.

14. The optical system according to claim 1, wherein the radiation device has an optical point or line pointer and wherein at least one axis of a coordinate system of the radiation device is displayable on the target object by the optical point or line pointer.

15. The optical system according to claim 1, wherein the radiation device has a pilot beam pointer, wherein a polar axis of a coordinate system of the rotational pointer is displayable by the pilot beam pointer of the radiation device, and/or wherein the radiation receiver has a pilot beam pointer, wherein a polar axis of a coordinate system of the radiation receiver is displayable by the pilot beam pointer of the radiation receiver.

16. The optical system according to claim 1, wherein the first operating mode includes a self-aligning mode activateable automatically via the control and computing unit, in which self-aligning mode a coordinate system of the radiation device is alignable with a coordinate system of plan information and/or a coordinate system of a space of the target object.

17. The optical system according to claim 1, wherein the second operating mode includes a coordinate display mode that is activateable automatically by the control and computing unit, in which coordinate display mode a selected coordinate point in a coordinate system of the radiation device is displayable in an aligned state.
